(19) United States
(12) Patent Application Publication
(10) Pub. No.: US 2014/0196423 A1
(43) Pub. Date: Jul. 17, 2014

(54) Tactile Air Filter Media

(71) Applicant: AMERICAN AIR FILTER COMPANY INC, Louisville, KY (US)

(72) Inventors: William D. Barrows, Louisville, KY (US); Lewis Sanders, Fayetteville, AR (US)

(73) Assignee: AMERICAN AIR FILTER COMPANY INC, Louisville, KY (US)

(21) Appl. No.: 13/739,634

(22) Filed: Jan. 11, 2013

(51) Int. Cl. B01D 46/10

(52) U.S. Cl. CPC B01D 46/10
USPC 55/501; 55/524; 55/511; 427/244

(57) ABSTRACT

An apparatus and method for a tactile air filter including a filter media composed primarily of glass fibers having a softening finish applied thereto.

### CROSS-REFERENCE TO RELATED DOCUMENTS

None.

### TECHNICAL FIELD

The invention relates generally to an apparatus for filtering particulates from a stream of air. More specifically, the invention relates to an air filter having a fiber finish for softening the filter media.

### BACKGROUND

It is desirable to provide filter media in certain streams of air to remove particulates from streams of air because such particulates can cause damage to equipment, for example, HVAC equipment. It is further desirable to inexpensively provide filtering media that has a soft finish because a soft finish causes less irritation.

It is common in the art to use a filtering media that may be made of any of a variety of materials, including, for example, a plurality of glass fibers, or fiberglass. However, fiberglass filter media can be harsh and therefore irritate the skin of one who handles it. Buyers and/or end users of air filters often prefer to avoid such irritation.

One means to combat the irritating harshness often associated with handling fiberglass is to use as a filtering media other types of material, such as, for example, polyester fibers or cotton-polyester fiber blends. Filter media made of polyester fibers or cotton-polyester fiber blends, or possibly other materials, may be considerably less harsh, or softer, than an otherwise similar filter media made of fiberglass. However, it is generally more expensive to produce filtering media composed primarily of polyester fibers or cotton-polyester fiber blends. This added expense can create a problem in the marketplace as buyers and/or end users of air filters often prefer less expensive options.

Thus, it would be highly desirable to make an air filter having a media that simulates the soft feel of polyester fiber or cotton-polyester fiber blends and therefore limits the irritating effects of handling it, while simultaneously maintaining the lower cost of production enjoyed when producing fiberglass filter media.

### SUMMARY

The present disclosure is directed towards inventive methods and apparatus for an air filter with a tactile fiber finish. The air filter with a tactile fiber finish is, in various embodiments, a filter media comprising a plurality of glass fibers that may be supported by a frame. The glass fibers have deposited thereon a binding agent to facilitate bonding of the fibers thus forming the filter media, as well as a finishing agent that reduces the harshness of the fibers.

Generally, in one aspect, a tactile air filter is provided for reducing the harshness of the fibers, thereby giving the filter a softer feel and reducing irritation to those who handle it. The tactile air filter includes a filter media that is formed of a plurality of glass fibers and the filter media has at least one surface and also an interior. There is a cured base resin that is interspersed over the surface and throughout the interior of the filter media that bonds the glass fibers together. There is also a layer of tactile fiber finish that is that is interposed between the cured base resin and the ambient air. The tactile fiber finish layer is bonded to the cured base resin and encapsulates the base resin and the glass fibers. The tactile fiber finish layer is interspersed over the surface and throughout the interior of the filter media.

In some embodiments, the cured base resin is urea formaldehyde.

In some embodiments, the fiber finish layer is a film of hydrocarbon resulting from the melting of polybutene polymer.

In some embodiments, the cured base resin has a dry base resin component and the fiber finish has a dry fiber finish component. In these embodiments, the web of glass fibers has a weight of approximately 1.8 to 4 times the weight of the dry base resin component and the dry fiber finish component has a weigh approximately 2% of the weight of the dry base resin component.

In some embodiments, there is also a frame that frames the filter media, the cured base resin, and the fiber finish layer.

In some embodiments, the frame includes a truss structure that at least partially covers at least one surface of the filter media.

In some embodiments, the filter media is compressed by the frame in at least one direction, thereby creating a friction fit.

In some embodiments, the compressed filter media is also adhered to the frame to help secure the filter media in fixed relation to the frame.

In some embodiments, the layer of fiber finish softens the fiberglass filter media to provide a tactile feel similar to polyester fiber air filter media.

Generally, in another aspect, a method of forming a tactile air filter is provided. The method includes forming a web of glass fibers into a filter media suitable for filter a fluid flow. The method also includes atomizing a base resin. The method further includes spraying the atomized base resin from a spray head toward the web of glass fibers during the forming of the filter media. The method includes dripping fiber finish into the base resin spray thus the fiber finish and base resin spray agglomerate into a separate binary composite. The method also includes depositing the separate binary composite on the filter media. The method further includes curing the base resin on the filter media at a temperature sufficiently high to melt the fiber finish, thereby melting the fiber finish. The cured base resin is adhesive enough to bond to the glass fibers and to bond the glass fibers to one another. During curing, the melted fiber finish has a low enough surface energy in relation to the surface energy of the base resin to migrate to an outer position relative to the glass fibers, thereby forming an outer fiber finish layer.

In some embodiments, the separate binary composite is deposited on the web of glass fibers during the forming of the filter media.

In some embodiments, the separate binary composite is deposited on the web of glass fibers after the forming of the filter media.

In some embodiments, the glass fibers each have a diameter of approximately 5 to 50 microns.

In some embodiments, the base resin is substantially urea formaldehyde.

In some embodiments, the fiber finish is substantially polybutene polymer and the fiber finish layer is substantially a hydrocarbon film.

In some embodiments, the base resin has a dry base component and the fiber finish has a dry fiber finish component. In these embodiments, the web of glass fibers has a weight approximately 1.8 to 4 times the weight of the dry base resin component and the dry fiber finish component has a weight approximately 2% of the weight of the dry base resin component.

In some embodiments, the base resin is thermosetting and is cured to the glass fibers for approximately 0.5 to 2 minutes.

In some embodiments, the thermosetting base resin is cured at a temperature of approximately 300 to 650 degrees Fahrenheit.

In some embodiments, the fiber finish is dripped at a volumetric rate approximately equal to 2% of a volumetric spray rate of the atomized base resin spray.

In some embodiments, the volumetric spray rate of said atomized base resin spray is approximately 100-200 cubic centimeters per minute.

In some embodiments, the atomized base resin spray that is sprayed at a volumetric spray rate of approximately 100-200 cubic centimeters per minute is sprayed at a velocity of approximately 100-500 feet per second.

Generally, in another aspect, a method of forming a tactile air filter is provided. The method includes forming a web of glass fibers into a filter media suitable for filtering a fluid flow. The method also includes atomizing a base resin and atomizing a fiber finish. The method further includes spraying the atomized base resin through a first port of a spray head and spraying the atomized fiber finish through a second port of the spray head toward the web of glass fibers, so that the two sprays agglomerate into a separate binary composite. The method includes depositing the separate binary composite on the web of glass fibers. The method also includes curing the base resin on the filter media at a temperature sufficiently high to melt the fiber finish, thereby melting the fiber finish. The cured base resin is adhesive enough to bond to the glass fibers and to bond the glass fibers to one another. During curing, the base resin is viscous enough relative to the melted fiber finish to migrate to an inner position that is proximate to the glass fibers, thereby displacing the melted fiber finish to an outer position thereby forming an outer fiber finish layer.

In some embodiments, the separate binary composite is deposited on the web of glass fibers during the forming of the filter media.

In some embodiments, the separate binary composite is deposited on the web of glass fibers after the forming of the filter media.

In some embodiments, the glass fibers each have a diameter of approximately 5 to 50 microns.

In some embodiments, the base resin is substantially urea formaldehyde.

In some embodiments, the fiber finish is substantially polybutene polymer and the fiber finish layer is substantially a hydrocarbon film.

In some embodiments, the base resin has a dry base component and the fiber finish has a dry fiber finish component. In these embodiments, the web of glass fibers has a weight approximately 1.8 to 4 times the weight of the dry base resin component and the dry fiber finish component has a weight approximately 2% of the weight of the dry base resin component.

In some embodiments, the base resin is thermosetting and is cured to the glass fibers for approximately 0.5 to 2 minutes.

In some embodiments, the thermosetting base resin is cured at a temperature of approximately 300 to 650 degrees Fahrenheit.

In some embodiments, the atomized fiber finish is sprayed at a volumetric rate approximately equal to 2% of a volumetric spray rate of the atomized base resin spray.

In some embodiments, the volumetric spray rate of said atomized base resin spray is approximately 100-200 cubic centimeters per minute.

In some embodiments, the atomized base resin spray that is sprayed at a volumetric spray rate of approximately 100-200 cubic centimeters per minute is sprayed at a velocity of approximately 100-500 feet per second.

### BRIEF DESCRIPTION OF THE ILLUSTRATIONS

The above-mentioned and other features and advantages of this invention, and the manner of attaining them, will become more apparent and the invention will be better understood by reference to the following description of embodiments of the invention taken in conjunction with the accompanying drawings, wherein:

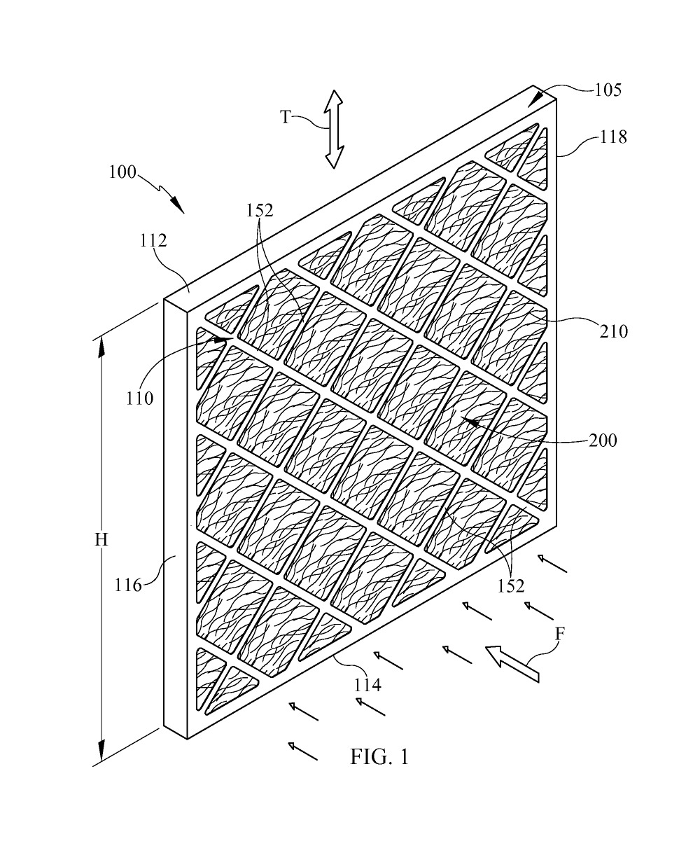

FIG. 1 depicts a perspective view of an embodiment of a tactile air filter media within a frame;

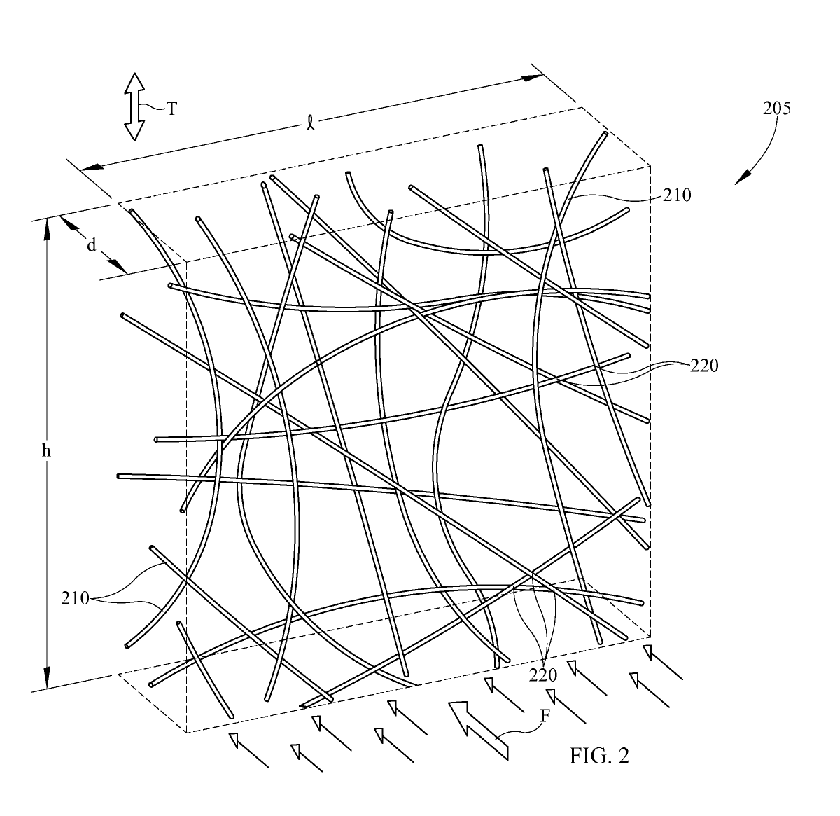

FIG. 2 depicts a close-up perspective view of an embodiment of a cross-section of a tactile air filter media;

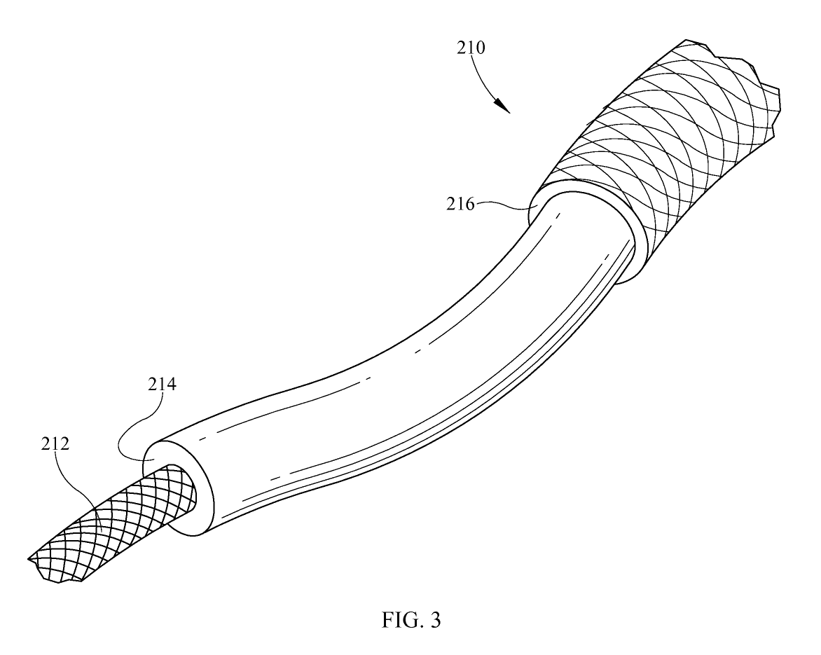

FIG. 3 depicts a close-up perspective view of an embodiment of an individual glass fiber with base resin and an outer fiber finish layer; and

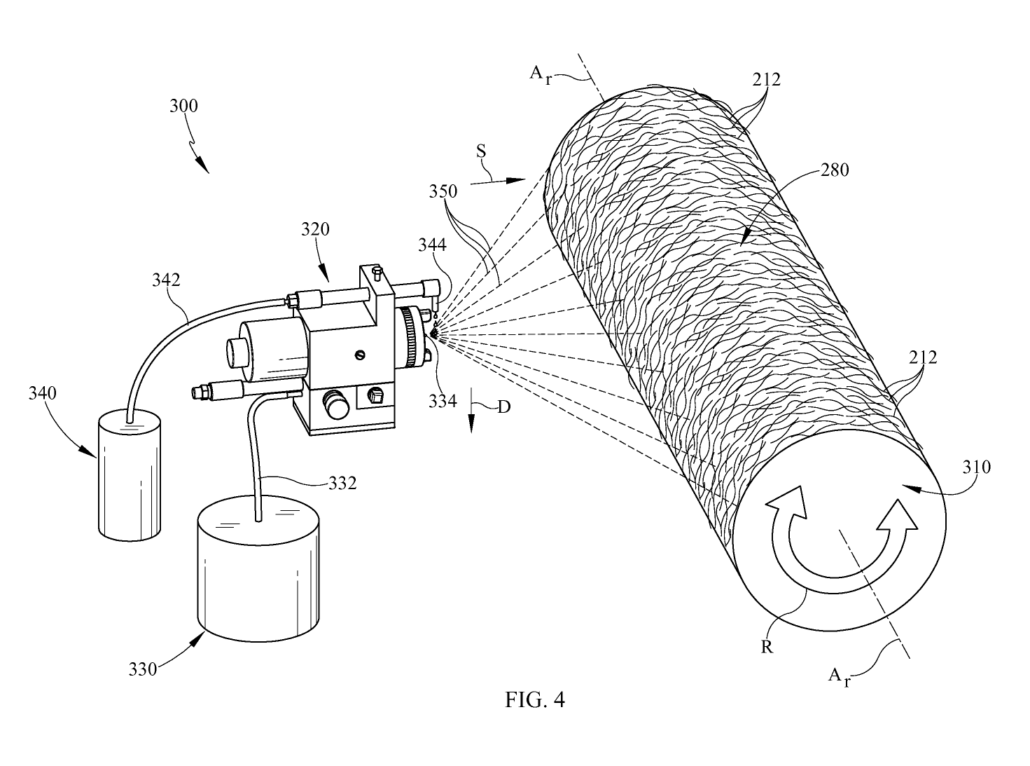

FIG. 4 depicts a perspective view of an embodiment of a system for forming a tactile air filter.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “bonded” and “attached” and variations thereof herein are used broadly and encompass direct and indirect connections, couplings, and mountings. In addition, the terms “bonded” and “attached” and variations thereof are not restricted to physical or mechanical connections or couplings.

Referring initially to FIG. 1, an embodiment of a tactile air filter 100 is illustrated as a finished filter media 200 comprising a plurality of finished glass fibers 210 and substantially framed by a frame 105. The frame 105 has a frame front 110, a frame top 112, a frame bottom 114, a frame first side 116, and a frame second side 118. The frame front 110 has a plurality of angled support members 152. The frame top 112, bottom 114, first side 116, and second side 118 define a frame perimeter. The finished filter media 200 has a height in the transverse direction T that is at least partially transverse to a fluid flow F. While depicted as substantially perpendicular to the fluid flow F, it is understood that the transverse direction T does not need to be perpendicular to the fluid flow F. The frame perimeter has a height H. Before being framed by the frame 105, the finished filter media 200 may have an unframed height that is greater than the frame perimeter height H. Thus, when the frame 105 is assembled around the finished filter media 200, the finished filter media 200 is compressed in the transverse direction T, thereby creating a friction fit with the perimeter of the frame 105. This friction fit may help secure the finished filter media 200 in place within the frame 105. Additionally, the finished filter media 200 may be adhered to frame top 112, bottom 114, first side 116, second side 118, and/or front 110 to further secure the filter media 200 in place within the frame 105. It is understood that just a friction fit, just adhesion, both, or neither may be used to secure the finished filter media 200 in place within the frame 105. The front face 110 has a plurality of angled support members 152 spanning a substantially parallel front surface of the finished filter media 200. The angled support members 152 may add torsional rigidity to frame 105. While depicted as angled at substantially 45 degrees relative to the frame top 112, bottom 114, and/or sides 116,118, it is understood that angled support members 152 may be angled at other than 45 degrees, including, but not limited to, being perpendicular to the frame top 112, bottom 114, and/or sides 116, 118. It is further understood that some embodiments may not include angled support members 152. While the frame 105 is depicted as being substantially square in shape, it is understood that the frame 105 may any of a variety of other shapes, including, but not limited to, rectangular, triangular, polygonal, round, or any other shape. It is even further understood that the frame 105 may be made of any of a variety of materials, including, but not limited to, paper, cardboard, wood, plastic, metal, or any other material.

Referring now to FIG. 2, an embodiment of a filter media cross-section 205 is depicted having a plurality of finished glass fibers 210 that intersect at a plurality of intersection points 220. It is understood that some embodiments may use fibers that have any of a variety of different finishes, and/or fibers that are made of any of a variety of materials, including, but not limited to, glass, polyethylene, cotton-polyester, or any other material. The filter media cross-section 205 has a length l, a height h, and a depth d. Height h extends in the transverse direction T. Length l extends in a direction substantially perpendicular to the transverse direction T. Height h and length l define a plane that is substantially parallel to the frame front 110, the front surface of the finished filter media 200 (see FIG. 1), and/or a rear surface of the finished filter media 200 (not shown). Depth d extends in a direction perpendicular to the plane defined by height h and length l and in a direction that extends from the front surface to the rear surface of the finished filter media 200. The intersection points 220 of finished glass fibers 210 are distributed throughout the filter media cross-section 205. In some embodiments, the finished glass fibers 210 may have bonded thereto a bonding agent, such as, for example, an urea formaldehyde resin, or any other of a variety of bonding agents having desirable bonding characteristics. Such desirable bonding characteristics may include, but are not limited to, the ability to cling and wick to glass fibers by hydrogen bonding and capillary wicking forces, the ability to cure at elevated temperatures, high tensile strength, low water absorption, and any other of a number of characteristics. A bonding agent, such as, for example, an urea formaldehyde resin, bonds the finished glass fibers 210 together at intersection points 220, thereby aiding the finished filter media 200 in maintaining its shape and the orientation of the glass fibers 210 therein. Without a bonding agent aiding the finished filter media 200 in maintaining its shape, some unfinished glass fibers 212 (see FIG. 3) may yield and/or deflect more than desirable, especially when subjected to external forces such as fluid flow F. Any yielding and/or deflecting of the fibers in an air filter may create undesirably large gaps in the filtering media and/or cause the fibers to bunch and overly restrict fluid flow F in some areas, thereby lowering filtering efficiency, increasing pressure drop across the filter, and/or otherwise inhibiting the filtering capability of the filter.

Referring now to FIG. 3, an embodiment of a finished glass fiber 210 is depicted with portions cut away to illustrate an unfinished glass fiber 212 with a base resin 214 bonded thereto, as well as a tactile fiber finish layer 216 disposed at an outer position relative to the unfinished glass fiber 212. The unfinished glass fibers 212 may each have a diameter of approximately 5 to 50 microns, although it is understood that smaller or larger diameters may also be used. As discussed above, in this embodiment the base resin 214 is a bonding agent, such as urea formaldehyde. The tactile fiber finish layer 216 comprises a material that provides a softer feel than an unfinished glass fiber 212, or an unfinished glass fiber 212 coated with the base resin 214 but substantially no tactile fiber finish layer 216. In some embodiments, the tactile fiber finish layer 216 is substantially a hydrocarbon film. A layer of hydrocarbon film may be provided by melting polybutene polymer or any other of a variety of materials having desirable tactile fiber finishing characteristics. An example of one desirable fiber finishing characteristic is having a relatively low surface energy in a melted state so that the tactile fiber finish will preferentially seek an air interface, or naturally seek ambient air, which is generally at an outer position relative to the finished fiber. As an illustrative example that is understood to not be limiting to the example provided, polybutene has a satisfactorily low surface energy, or surface tension, that may be approximately 25 dynes/cm (or approximately 0.025 N/m at 20 degrees Celsius). Continuing this example, the polybutene also has a satisfactory specific gravity of approximately 0.81-0.91 at 15 degrees Celsius in its liquid state. The liquid, or melted, hydrocarbon film having a relatively low surface energy will migrate to an air interface to minimize its energy state, which may be measured in dynes per centimeter, as characterized by physical chemistry parameters such as Gibbs Free Energy, Entropy, and the like. Thus, the urea formaldehyde binder resin and polybutene polymer may be simultaneously located on the unfinished glass fiber 212, or a plurality of unfinished glass fibers 212; subjected to curing temperatures that will cure the urea formaldehyde base resin and bond it to the unfinished glass fibers 212 as well as bonding the glass fibers 210, 212 at their intersection points 220, and melt the polybutene polymer producing liquid hydrocarbon that will seek ambient air at an outer position relative to the unfinished glass fiber 212; thus forming the finished glass fibers 210. It is understood that any of a variety of materials, or any combination thereof, may be used to achieve the desired tactile feel, including, but not limited to: wax dispersions such as paraffin, carnauba, polyethylene, and polypropylene, and/or polybutene emulsions, such as those commercially available from Michelman, Inc.; and/or alkyl ketene dimer paper (“AKD”) and/or [AQUAPEL] fabric sizing emulsions commercially available from Ashland, Inc.

Referring now to FIG. 4, an embodiment of a system for forming the tactile air filter 100 is illustrated. In this embodiment, there is generally a rotating drum 310 upon which is situated a fiber mat 280 generally comprising a plurality of glass fibers 212. The rotating drum 310 rotates in a rotational direction R about a rotational axis Aᵣ. Also generally depicted is a spray head 320 with a first supply line 332 and a second supply line 342, a spray nozzle 334, and a dripper 344. The first supply line 332 attaches a binder resin supply 330 to the spray head 320. The second supply line 342 attaches a fiber finish supply 340 to the spray head 320. The base resin may be transported from the base resin supply 330 to the spray head 320 by any of a variety of means, including, but not limited to, pumping, pushing, pulling, sucking, and/or using a gravity feed, and/or any other means of transportation. Similarly, the fiber finish may be transported from the fiber finish supply 340 to the spray head 320 by any of a variety of means, including, but not limited to, pumping, pushing, pulling, sucking, and/or using a gravity feed, and/or any other means of transportation. The spray head 320 has attached thereto, and/or is in close proximity with, the spray nozzle 334. In this embodiment, there is an atomizer within the spray head that transforms the base resin from a liquid state to a gaseous and/or an aerosol state. Pressure atomizing, air atomizing, and/or any other process for atomizing a liquid into an aerosol may be utilized for any atomization disclosed herein. The atomized base resin is then transferred to the spray nozzle 334 from which it is sprayed in the spray direction S toward the fiber mat 280. The spray head 320 also has attached thereto, and/or is in close proximity with, a drip faucet 344. In this embodiment, the fiber finish supply line 342 carries the fiber finish in a liquid state to the drip faucet 344 from which it is dripped in a drip direction D that is transverse to the spray direction S. The drip faucet 344 is aligned with the spray nozzle 334 in the drip direction D, thus the fiber finish is dripped into the base resin spray and the two constituents agglomerate into a separate binary composite. In the separate binary composite, for example a separate binary composite containing a urea formaldehyde constituent and a polybutene polymer constituent, the constituents do not mix together and each retains its properties.

In some embodiments, a sufficient amount of the atomized base resin is sprayed from the spray nozzle 334 with sufficient velocity to have enough inertia to carry the separate binary composite to the fiber mat 280. In some embodiments, the atomized base resin is sprayed at a volumetric rate of approximately 100 to 200 cubic centimeters (cc) per minute at a velocity of approximately 100 to 500 feet per second (fps) and the fiber finish drips at a volumetric rate wherein the dry fiber finish component is approximately equal to 2% of the volumetric rate of the dry component of the base resin. In an illustrative example, which is provided only as an illustration and is not to be construed as a limitation, 200 cc per minute of atomized base resin at 50% dry component (i.e. 100 cc per minute dry base resin component) is sprayed at a velocity of 100-500 fps toward the fiber mat 280, and the fiber finish is dripped at a rate of 4 cc per minute at 50% dry component (i.e. 2 cc per minute dry fiber finish component). In this illustrative example, the ratio of base resin to glass fiber may be 20-35% binder to 65-60% glass fiber, and the glass fiber may be produced and/or introduced at a rate of approximately 40 pounds of glass fiber per hour. It is understood that the constituents may be dripped at other rates and/or velocities and that the ratio of dry fiber finish component to dry base resin component is not limited to 2%, but the ratio may be higher or lower than 2%. In some embodiments, the spray from the spray nozzle may produce droplets having sub-millimeter diameters, or diameters in the micron range. In some embodiments, the drip may produce droplets having a diameter of 0.5 to 7 mm. It is understood that other diameters of droplets may be produced and/or used without substantially deviating from the disclosure herein. In some embodiments the base resin is transported in a liquid state from the base resin supply 330 to the spray head 320 via the first supply line 332. The base resin may contain a dry component, for example substantially dry urea formaldehyde that is mixed with water, or any of a variety of other liquids, to form the base resin. Similarly, a dry fiber finish component, for example substantially dry polybutene polymers, may be emulsified in water to form the tactile fiber finish. The dry base resin component and/or the dry fiber finish component may be in a powdered form to facilitate mixing and/or combining with water, but it is understood that they do not need to be in a powdered form. In some embodiments, it may be advantageous to use dripping equipment that is somewhat separated from the spraying equipment, as this would allow the dripping equipment to be assembled and disassembled independently of the spraying equipment, which may be preferable to avoid disturbing the spraying equipment settings and therefore ensure a continued precise dosing ratio of base resin to glass fiber.

In some embodiments the tactile fiber finish may be atomized and sprayed, instead of dripped, similarly to how the base resin is atomized and sprayed in the embodiment discussed above. In these embodiments, the tactile fiber finish and base resin are transported to the spray head via separate supply lines, separately atomized, and sprayed through one spray nozzle, or through separate but proximate spray nozzles, so the atomized base resin and atomized fiber finish agglomerate into a separate binary composite that is transferred to the fiber mat. In embodiments having a tactile fiber finish spray instead of drip, the separate binary composite may agglomerate into a finer spray, which may advantages and/or disadvantages that are readily apparent and understood in the art. Thus, either class of embodiments may be readily and advantageously utilized. It may be advantageous to keep the base resin from contacting the fiber finish until one or both of the constituents is sprayed, as this will allow for the base resin and fiber finish to be more evenly distributed on and throughout the fiber mat 280. Otherwise, if the base resin and the fiber finish are combined prior to spraying, there will be time for the constituents to separate prior to spraying, thus the constituents would be less evenly distributed on the fiber mat 280. In some embodiments, it may be advantageous to use fiber finish spraying equipment that is somewhat separated from the base resin spraying equipment, as this would allow the fiber finish spraying equipment to be assembled and disassembled independently of the base resin spraying equipment, which may be preferable to avoid disturbing the base resin spraying equipment settings and therefore ensure a continued precise dosing ratio of base resin to glass fiber.

The foregoing description of several embodiments of the invention has been presented for purposes of illustration. It is not intended to be exhaustive or to limit the invention to the precise steps and/or forms disclosed, and obviously many modifications and variations are possible in light of the above teaching. It is intended that the scope of the invention and all equivalents be defined by the claims appended hereto.

We claim:

1. A tactile air filter comprising:
a filter media formed substantially of a plurality of glass fibers and having at least one surface and an interior;
a cured base resin interspersed over said at least one surface and throughout said interior and bonded thereto in an effective amount to substantially adhere said plurality of glass fibers together;
a layer of fiber finish interposed between said cured base resin and an atmosphere of ambient air in an effective amount to substantially soften said filter media;
said layer of fiber finish substantially bonded to said cured base resin and encapsulating said cured base resin and said plurality of glass fibers; and
said layer of fiber finish interspersed over said at least one surface and throughout said interior of said filter media.

2. The tactile air filter of claim 1, wherein said cured base resin is substantially urea formaldehyde.

3. The tactile air filter of claim 1, wherein said layer of fiber finish is substantially a hydrocarbon film resulting from melting a polybutene polymer emulsion.

4. The tactile air filter of claim 1, wherein said cured base resin has a dry base resin component and said fiber finish has a dry fiber finish component:
said plurality of glass fibers having a weight approximately equal to 1.8 to 4 times a weight of said dry base resin component; and
said dry fiber finish component having a weight approximately 2% of said weight of said dry base resin component.

5. The tactile air filter of claim 1, further comprising a frame that substantially frames said filter media, said cured base resin, and said layer of fiber finish.

6. The tactile air filter of claim 5, further comprising a truss structure attached to said frame that at least partially covers said at least one surface of said filter media.

7. The tactile air filter of claim 5, wherein said filter media is at least partially compressed by said substantially rigid frame thereby creating a friction fit between said filter media and said substantially rigid frame.

8. The tactile air filter of claim 7, wherein said frame is adhered to said filter media.

9. The tactile air filter of claim 1, wherein said layer of fiber finish softens said filter media to provide a tactile feel similar to polyester fiber air filter media.

10. A method of forming a tactile air filter, comprising the steps of:
forming a web of glass fibers into a filter media suitable for filtering a fluid flow;
atomizing a base resin;
spraying said atomized base resin from a spray head substantially in a spray direction toward said web of glass fibers;
dripping a fiber finish drip in a drip direction transverse to said spray direction;
wherein said fiber finish drip is interposed between said filter media and said spray head during said spraying of said atomized base resin;
agglomerating said atomized base resin spray and said fiber finish into a separate binary composite;
depositing said separate binary composite on said web of glass fibers;
curing said base resin on said filter media at a temperature sufficiently high to melt said fiber finish, thereby melting said fiber finish;
wherein said cured base resin is sufficiently adhesive to bond to said glass fibers and to bond said glass fibers together at intersections of said glass fibers; and
wherein said melted fiber finish has a sufficiently low surface energy in relation to said base resin that said fiber finish substantially migrates to an outer position proximate to an atmosphere of ambient air, thereby forming an outer fiber finish layer.

11. The method of claim 10, wherein said separate binary composite is deposited on said web of glass fibers during said forming of said filter media.

12. The method of claim 10, wherein said separate binary composite drip is deposited on said web of glass fibers after said forming of said filter media.

13. The method of claim 10, wherein each of said glass fibers substantially has a diameter of approximately 5 to 50 microns.

14. The method of claim 10, wherein said base resin is substantially urea formaldehyde.

15. The method of claim 10, wherein said fiber finish is substantially polybutene polymer and said fiber finish layer is substantially a hydrocarbon film.

16. The method of claim 10, wherein said base resin has a dry base resin component and said fiber finish has a dry fiber finish component:
said web of glass fibers having a weight approximately equal to 1.8 to 4 times a weight of said dry base resin component; and
said dry fiber finish component having a weight approximately 2% of said weight of said dry base resin component.

17. The method of claim 10, wherein said base resin is thermosetting and is cured to said glass fibers for approximately 0.5 to 2 minutes.

18. The method of claim 17, wherein said thermosetting base resin film is cured at a temperature of approximately 300 to 650 degrees Fahrenheit.

19. The method of claim 10, wherein said fiber finish is dripped in said drip direction at a volumetric rate approximately equal to 2% of a volumetric spray rate of said atomized base resin spray.

20. The method of claim 19, wherein said volumetric spray rate of said atomized base resin spray in said spray direction is approximately 100-200 cubic centimeters per minute.

21. The method of claim 20, wherein said atomized base resin spray is sprayed in said spray direction at a velocity of approximately 100-500 feet per second.

22. A method of forming a tactile air filter, comprising the steps of:
forming a web of glass fibers into a filter media suitable for filtering a fluid flow;
atomizing a base resin;
atomizing a fiber finish;
spraying said atomized base resin through a first port of a spray head substantially in a spray direction toward said web of glass fibers;
spraying said atomized fiber finish through a second port of said spray head substantially in said spray direction toward said web of glass fibers;
agglomerating said atomized base resin spray and said atomized fiber finish spray into a separate binary composite;
depositing said separate binary composite on said web of glass fibers;
curing said base resin on said filter media at a temperature sufficiently high to melt said fiber finish, thereby melting said fiber finish;
wherein said cured base resin is sufficiently adhesive to bond to said glass fibers and to bond said glass fibers together at intersections of said glass fibers; and
wherein said base resin is sufficiently viscous in relation to said melted fiber finish film that said base resin film substantially migrates to an inner position proximate to said glass fibers and said melted fiber finish film is displaced to an outer position relative to said glass fibers, having said cured base resin film interposed therebetween, thereby forming an outer fiber finish layer.

23. The method of claim 22, wherein said separate binary composite is deposited on said web of glass fibers during said forming of said filter media.

24. The method of claim 22, wherein said separate binary composite is deposited on said web of glass fibers after said forming of said filter media.

25. The method of claim 22, wherein each of said glass fibers substantially has a diameter of approximately 5 to 50 microns.

26. The method of claim 22, wherein said base resin is substantially urea formaldehyde.

27. The method of claim 22, wherein said fiber finish is substantially polybutene polymer and said fiber finish layer is substantially a hydrocarbon film.

28. The method of claim 22, wherein said base resin has a dry base resin component and said fiber finish has a dry fiber finish component:
said web of glass fibers having a weight approximately equal to 1.8 to 4 times a weight of said dry base resin component; and
said dry fiber finish component having a weight approximately 2% of said weight of said dry base resin component.

29. The method of claim 22, wherein said base resin is thermosetting and is cured to said glass fibers for approximately 0.5 to 2 minutes.

30. The method of claim 29, wherein said thermosetting base resin film is cured at a temperature of approximately 300 to 650 degrees Fahrenheit.

31. The method of claim 22, wherein said fiber finish is dripped in said drip direction at a volumetric rate approximately equal to 2% of a volumetric spray rate of said atomized base resin spray.

32. The method of claim 31, wherein said volumetric spray rate of said atomized base resin spray in said spray direction is approximately 100-200 cubic centimeters per minute.

33. The method of claim 32, wherein said atomized base resin spray is sprayed in said spray direction at a velocity of approximately 100-500 feet per second.
